(19) United States
(12) Patent Application Publication
(10) Pub. No.: US 2008/0155427 A1
(43) Pub. Date: Jun. 26, 2008

(54) Mobile business client

(76) Inventors: Jean-Francois Leblay, Montreal (CA); Martin Fecteau, Boucherville (CA); Richard Pellerin, La Prairie (CA)

Correspondence Address: BRAKE HUGHES BELLERMANN LLP, C/O INTELLEVATE, P.O. BOX 52050, MINNEAPOLIS, MN, 55402, US

(21) Appl. No.: 11/643,467

(22) Filed: Dec. 21, 2006

(51) Int. Cl. G06F 15/16; G06F 3/048

(52) U.S. Cl. 715/744

(57) ABSTRACT

A method of performing delta updates of a Web based application running on a client device in a client-server system. Partial object trees are exchanged between a client and a server, which causes the updates of an object model cache on the client either via the instantiation, destruction or modification of objects in the model.

### TECHNICAL FIELD

This description relates to computer software and client-server based applications and, more particularly, to a mobile business client.

### BACKGROUND

The development of sophisticated software applications running on mobile devices typically involves the integration of processes running on a client device with processes running on a server. For example, a mobile client device may run a browser with an event handling system that communicates with an enterprise server over a network such as the Internet. The server can respond to requests generated by the browser and event handler, serve data to the client, and/or update presentation of the data on the client device.

A Web browser may provide a Graphical User Interface (“GUI”) for a software application running on a mobile client device. Typically, a browser running on the client device interprets Hypertext Markup Language (“HTML”) code received from the server and displays a GUI to the client. For this reason, these types of software applications that utilize a browser on the client device communicating with a server have been commonly referred to as Web-based applications. Examples of technologies for building Web-based applications include server page technologies (“xSP”) such as active server pages (“ASP”) from Microsoft Corporation or Java Server Pages (“JSP”) from Sun Microsystems, Inc.

It is often convenient to specify a GUI for an application using metadata. Metadata is data that describes other data and can be viewed as a layer of abstraction for the actual data that it is describing. It is often convenient to use metadata because it can be easily manipulated and provides a layer of abstraction that allows rendering of the metadata into any number of diverse formats and on different device platforms. Often metadata is encoded in Extensible Markup Language (“XML”). XML metadata describing a particular GUI layout may provide a generic representation of a GUI. The GUI may be displayed based on the XML metadata by invoking GUI libraries, which are device and platform specific.

For example, XML code may specify a main window that includes two smaller windows, the first of the smaller windows displaying stock ticker data and the second smaller window displaying weather information. The XML code may indicate the general layout and structure of the GUI.

XML metadata may also specify particular GUI objects. A GUI object may be defined in an abstract manner such as, for example, by using metadata to provide an object description of the underlying behavior of the object. GUI objects may include, for example, various user interface elements, such as tables, list boxes, combo-boxes, buttons, and any other types of controls that are used either to display data and/or provide for user interaction to render a Web-based application.

Particular technical challenges arise when a mobile device operate as client devices in Web-based applications. A mobile device is a small footprint device that may be easily used in the field or during travel. The technical challenges that arise in using mobile devices as client devices in Web-based applications relate to the nature of the wireless environment in which these devices generally operate as well as the heterogeneity of platforms, operating systems, and software architectures running on these devices.

In particular, due to the diversity of mobile device architectures and operating systems, it is difficult to reuse code running on one mobile device on another mobile device. This is because different mobile devices (e.g., Blackberry Personal Digital Assistants (“PDA”), Treo PDAs, Nokia mobile phones, and Motorola mobile phones) typically use different hardware architectures and operating systems. Thus, the heterogeneous nature of mobile devices raises significant development hurdles for code reuse because the client software running on each mobile device must be rewritten to accommodate the idiosyncrasies of that device's operating system and hardware platform.

Another issue relates to bandwidth consumption in the wireless environment where mobile devices operate. Because bandwidth is particularly scarce and expensive in wireless networks, it is desirable to conserve as much bandwidth as possible. However, the standard mechanism for retrieving Web pages creates a significant potential for bandwidth mismanagement. This problem relates to the nature of a protocol called Hypertext Transfer Protocol (“HTTP”), which is the standard protocol for Web-based data exchange. HTTP generally requires a full page refresh even when only a small amount of data may have changed on a page. In a Web-based application, whenever a Web page needs to be refreshed on a client device, typically the entire body of the Web page is transmitted from the server to the client. Thus, a new Web page may have changed only slightly and yet even the portions of HTML code that have not changed are nonetheless transmitted from the server to the client.

For example, a user may run a Web-based application on a mobile device that displays one or more combo boxes to the user. A combo box is a GUI element that provides a combination of a drop-down list and a text box that allows the user to type a value directly into the control and also allows the user to pick from a list of existing options. When the user makes a selection in one combo box, new entries may be presented in a second combo box. When using HTTP to serve the application to the user, rather than obtaining only the data that needs to be displayed in the second combo box the entire page must be retrieved. In addition, if the set of values for the second combo box is too large and the GUI would display only a small subset of all the values due to inherent limitations in the GUI, an unnecessary load may be placed on the system to retrieve the complete set when only a fraction of the full set actually would be used. In general, the need to retrieve an entire page when only a portion of the page has changed places an unnecessary load on the network traffic and client/server processing.

A significant technical challenge in providing delta management for a GUI displayed on a client device is how to efficiently maintain state information for the GUI. State information relates to any data that represents the current state or status of a software application. In the case of a GUI 140, for example, state information may include information regarding the current windows that are open for an application, the placement of the windows on the screen as well as particular data that may be shown in fields of various GUI elements (e.g., a text box).

As a user (not shown) interacts with the application, the state of the GUI may change. For example, the user may move windows around the screen, or may enter text in various fields associated with GUI elements such as text boxes. The user may also perhaps click on various GUI elements such as a button. All of these actions may cause the state of the GUI to change. In order to for delta management for a GUI to be operable, it is necessary to maintain this state information at the client device in an efficient form so that only information pertaining to changes in the GUI (i.e., the delta information) need be exchanged with the server.

### SUMMARY

According to one general aspect, a method of performing delta updates of a Web based application running on a client device in a client-server system is provided. The method includes storing an object tree on the client, where the object tree specifies at least one Graphical User Interface (“GUI”) object for the application, storing in an object cache on the client at least one instance of the GUI object specified in the object tree, and detecting a user interaction with the GUI object. Upon detection of the user interaction with the GUI object, a first portion of an object tree is generated based on the user interaction, and the first portion of the object tree is transmitted from the client to a server. A second portion of an object tree is received from the server; and upon receiving the second portion, the object tree stored on the client is modified based upon information in the second portion. The cache is then updated based upon information in the second portion.

According to another general aspect, a system is provided for performing delta updates of GUI information for a Web-based application. The system includes a memory element adapted for storing an object tree, where the object tree specifies at least one Graphical User Interface (“GUI”) object for the application, an object cache adapted for storing at least one instance of a GUI object specified in the object tree, and a processor adapted to: modify a portion of the object tree to reflect the user interaction upon detecting a user interaction with a GUI object; transmit a first portion of the object tree from the client to a server, where the first portion corresponds to the modified portion of the object tree; receive a second portion of the object tree from the server, modify the object tree to reflect the second portion; and, update the object cache to reflect the objects specified in the object tree.

According to another general aspect, a client adapted to provide delta updates of GUI information for a Web-based software application includes a protocol handler adapted to communicate with a server to receive an object representation of GUI information for the application, a parser adapted to parse the object representation and generate at least one instance of an object specified in the object representation, a cache adapted to store the at least object instance generated by the parser; and, a User Interface (“UI”) controller, where the UI controller renders a GUI based on objects stored in the cache.

The details of one or more implementations are set forth in the accompanying drawings and the description below. Other features will be apparent from the description and drawings, and from the claims.

### BRIEF DESCRIPTION OF THE DRAWINGS

FIG. 1A is a detailed block diagram of an architecture for implementing a Web-based application that provides delta management for GUI objects.

FIG. 1B is a detailed block diagram of a client device including a mobile business client for providing delta management and a server.

FIG. 2 is a block diagram of a mobile business client.

FIG. 3A is a block diagram of a Smart Client Extensible Markup Language (“SCXML”) schema.

FIG. 3B schematically shows how various types specified in a SCXML document may correspond to various GUI elements.

FIG. 4 is a flowchart depicting steps performed by a mobile business client in order to support delta management.

### DETAILED DESCRIPTION

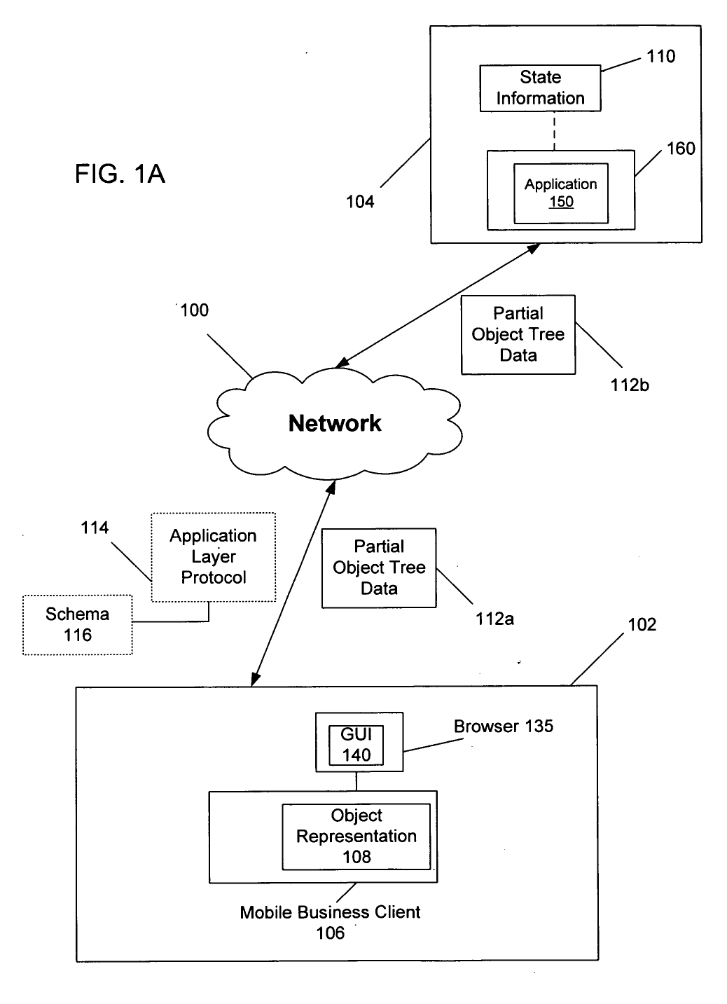

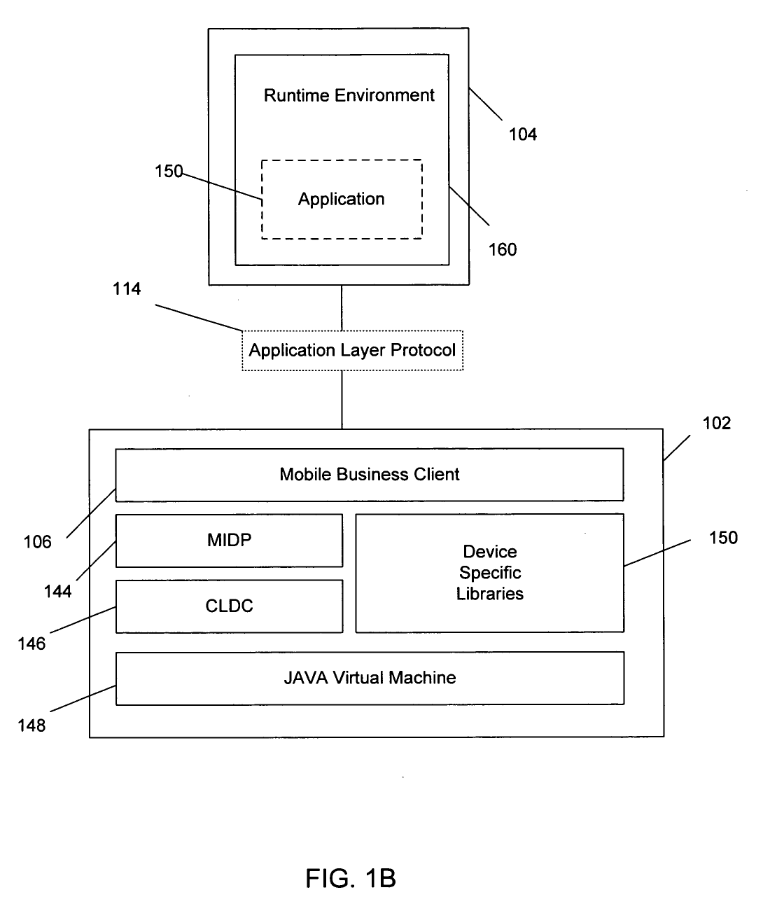

FIG. 1A is a detailed block diagram of an architecture for implementing a Web-based application that provides delta management for GUI objects. The concept underlying delta management for a GUI 140 is to detect those portions of the GUI 140 that may have changed in a client-server application and transmit information only relating to the changed portions of the GUI 140

As shown in FIG. 1A, a Web-based application 150 can be executed by a client 102 and a server 104. The server 104 can include a runtime environment 160 that allows execution of an application 150. The client 102 may establish communication with the server 104 over a network 100 such as the Internet using a protocol such as TCP/IP. The network 100 may be any network for exchanging electronic data, such as, for example, a General Packet Radio Services (“GPRS”) network or an Enhanced Data Rates for GSM Evolution (“EDGE”) network.

An application layer protocol 140 may be provided that allows for the exchange of data relating to the GUI 140 via the network 100. The application layer protocol 140 may also specify a schema 112 defining the structure and organization of various GUI elements that may be displayed via the GUI 140. A schema for an XML document (e.g., SCXML) may be a tree structure and may specify any number of GUI objects that may be displayed to a user. GUI objects may include such elements as windows, buttons, text boxes and any other element that may be utilized in a GUI for an application.

The application layer protocol 114 may also provide for the exchange of portions of an object tree (herein referred to as a partial object tree). An object tree may represent any information structured according to the schema 112. Thus, if XML is used, a partial object tree may include XML data that is structured according to an SCXML schema.

According to one embodiment the application layer protocol may be the Business Client Protocol (“BCP”) 114 provided by SAP. Because partial object trees 112a and 112b transmitted by the client 102 and the server 104 share a common schema (i.e., SCXML), it is possible to exchange elements that are defined by the schema between the client 102 and the server 104. For example, as described below, one SCXML schema specifies window elements, data elements, simple type elements, etc. A window element may be any XML metadata relating to a window object for a GUI 140.

The client 102 may invoke the execution of a Web-based application 150 and establish an application session. During the application session, a user (not shown) may interact with the GUI 140 on the client 102, which may cause the client 102 and server 104 to exchange data relating to the application 150 in the form of partial object trees 112a and 112b, which are structured according to the schema 112. The partial object trees 112a and 112b may include metadata for the GUI 140 displayed on the client 102 via browser 135 and may be encoded in XML. The server 104 may maintain a record regarding the partial object trees 112a and 112b exchanged between the client 102 and the server 104 during an application session. Although FIG. 1A shows the GUI 140 as being provided via browser software 135, it should be understood that the GUI may be provided via some other software structure.

The exchange of partial object trees 112a and 112b via the application layer protocol 114 may be viewed as providing a protocol specific representation of a GUI 140. That is, the partial object trees 112a and 112b provide information relating to the GUI 140 in a protocol specific format. In order to enable delta management for the GUI 140 it may be necessary to transform the protocol specific representation of the GUI provided by partial object trees 112a and 112b into a state representation and maintain this state information on the client 102 so that the information exchanged between the client 102 and the server 104 does not have to be retransmitted again at a later time.

In order to generate and maintain state information for a GUI, a mobile business client (“MBC”) 106 may transform the protocol specific representation of a GUI (i.e., partial object trees 112a and 112a) into an object representation 108. An object representation 108 may include a plurality of objects that are instantiated, destroyed, or modified based upon partial object trees 112a and 112b exchanged between the client 102 and the server 104.

FIG. 1A shows that a client 102 may execute a mobile business client (“MBC”) 106. The MBC 106 may detect actions generated by a user interacting with the GUI causing the generation of a partial object tree 112a reflecting the action and may transmit the partial object tree 112a to the server 104. The MBC 106 may also receive a partial object tree 112b from the server (in response to the transmitted object tree 112a), which it may process to update the object representation 108 based on partial object tree data 112b received from the server 104. The structure and function of the MBC 106 and the object representation 108 will be described in detail below. For present purposes, it is sufficient to understand that the object representation 108 may provide state information for the GUI 140.

FIG. 1B is a detailed block diagram of a client device including a mobile business client for providing delta management and a server. The server 104 can provide a runtime environment 160 for executing an application 150. The server 104 can communicate with the client 102 via an application layer protocol 114. The application layer protocol 114 may be the BCP provided by SAP AG. As described in more detail below, the application layer protocol 114 may provide for an exchange of partial object trees 112a and 112b between the client 102 and the server 104. For example, the business client protocol 114 may provide for the exchange of SCXML data specifying GUI objects for the application 150.

The client 102 can include a mobile business client 106, a JAVA virtual machine 148, a Mobile Information Device Profile (“MIDP”) 244, a Connected Limited Device Configuration (“CLDC”) 246, and device specific libraries 250. The MIDP 144 and CLDC 146 collectively provide a JAVA runtime environment for the client 102. The JAVA virtual machine 148 is a platform independent execution environment that converts JAVA bytecode into machine language and executes it. The device specific libraries 150 are collections of routines that provide functions that may be specific to a particular device. For example, the device specific libraries may have specific functions for invoking GUI functions on the client 102. As described in more detail below, the mobile business client 106 may provide functionality for performing delta management of GUI objects for the application 150.

Although the architecture shown in FIG. 1B relates to a JAVA implementation (implementation of a JAVA runtime environment), it should be understood that the present invention is compatible with any programming language, runtime environment and/or framework. Thus, for example, the present invention may be implemented on the .NET platform by Microsoft Corporation using the C# programming language.

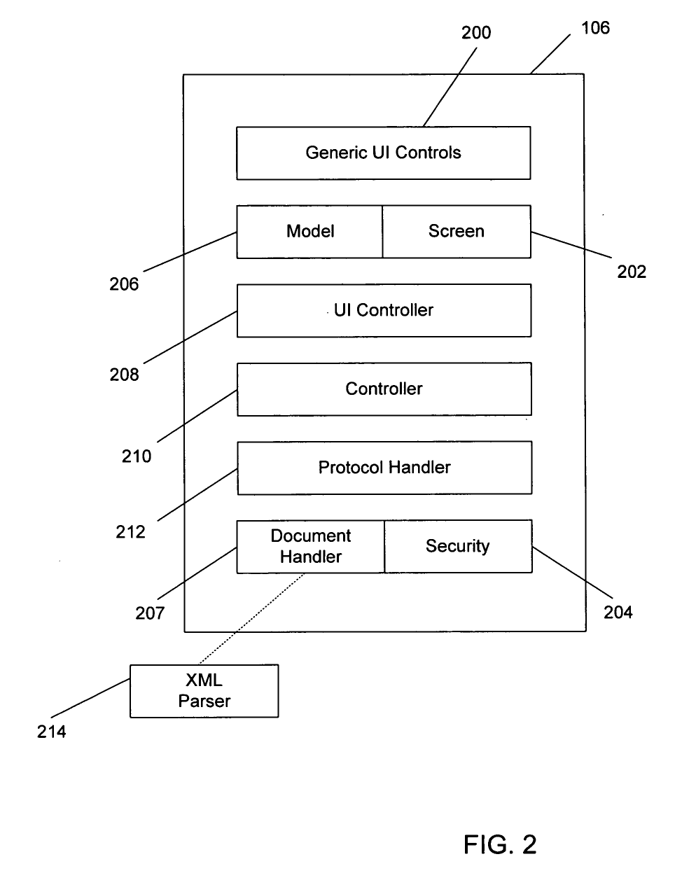

FIG. 2 is a block diagram of a mobile business client (“MBC”) 106. Client software refers to software running on a client device such as a mobile device that provides an interface for communication with a server. The client software may make use of services on the server and may also provide other management functions on the client device to facilitate the operation of client server interactions.

The MBC 106 may provide services for conserving bandwidth when the client 102 participates in the execution of a Web-based application. The MBC 106, making use of services supported by the application layer protocol 114, may provide for delta management of data related to the GUI 140 implemented on the client device 102. In particular, the MBC 106 may provide functions for detecting an action caused by a user interacting with the GUI 140, generating a partial object tree 112a reflecting the action and transmitting the partial object tree 112a to the server 104 using an application layer protocol 114. The MBC may then receive a partial object tree 112b from the server 104 and cause the model 206 to be updated based upon the received partial object tree 206. The updating of the model 206 may include the instantiation of objects, the destruction of objects and/or the alteration of objects (e.g., changing the value of a member variable or attribute for an object).

The MBC 106 may include various functional blocks including generic controls 200, a model 206, a screen 202, a UI controller 208, a controller 210, a protocol handler 212 and a document handler 207, which may make use of the services of an XML parser 214 and security controls 204. The function of these blocks and their respective roles in providing for delta management will be described below.

The controller 210 may orchestrate the overall operation of various functional blocks of the MBC 206 such as the protocol handler 212, the document handler 207, the UI controller 208, etc.

The protocol handler 212 may provide for communication with the server 104. The protocol handler 212 may transmit a partial object tree 110a to the server 104 using the application layer protocol 114 and an underlying transport protocol such as TCP/IP. The protocol hander can also receive a partial object tree 112b from the server 104, which it then may pass to the document handler 207 for parsing.

The User Interface (“UI”) controller 208 may control UI rendering. In particular, upon detection of an action by a user, the UI controller 208 may create a partial object tree 112a and may request the protocol handler 212 to send the partial object tree 112a to the server 104. Upon receiving a response from the server 104 via the protocol handler 212, the controller 210 may request the UI controller 208 to render the received page.

The UI controller 208 may be platform independent. The UI controls may be created using device specific libraries. The other functional blocks in the MBC such as the controller and model are generic structures that do not invoke particular functions for specific mobile device. Because the UI controller is a discrete block in the MBC, it may easily be replaced for different mobile devices. The UI controller may include the implementation of UI controls, based on the generic control interfaces. Thus, the architecture of the MBC provides for the reuse of the majority of the MBC code from device to device (platform to platform). The only portion of code that may need to be altered for different devices is the actual device specific UI libraries. This allows very rapid code development in implementing the MBC on a new mobile device (as long as it is Java-based).

The generic controls element 200 can specify generic controls, which ultimately need to be implemented for the specific device of a platform. For example, in the case of a button, which is a generic control, rendering of the button must be implemented using some libraries. For example, if the MBC 106 is running on a Blackberry device made by Research In Motion, Inc., the button can be implemented using the Blackberry Application Programming Interface (“API”). That is, the implementation of a particular control is determined by the specific device that will render it. The use of a generic controls element 200 may only be necessary for a device independent implementation, for example using JAVA (making use of the MIDP/CLDC libraries). For example, if the MBC were built using the .NET framework to run on Windows Mobile devices, the abstraction provided by the generic controls element would not be required.

The screen 202 provides support for dynamic screen behavior and provides a main container for the UI controls. The model 206 may store state information about the GUI 140 associated with the application 150. The state information may include instances of GUI objects, which may be stored in a cache. Class definitions for various objects instantiated in the model 206 may be provided by class libraries, such as JAVA class libraries (not shown). The model 206 may be updated upon receipt of a partial object tree 112b from the server 104. In particular, object instances may be created, destroyed, or altered in the model 206 based information in a partial object tree 112b received from the server 104.

According to one embodiment, a partial object tree 112b may be received by the protocol handler 212. The partial object tree may be encoded in XML. The protocol handler 212 may then pass the XML code to the document handler 207, which utilizes the XML information (making use of services provided by the XML parser 214) to either to create, destroy or alter objects in the model. XML comes to protocol handler. Thus, the document handler 207 may cause the instatiation or destruction of objects in the model 206.

According to one embodiment, the BCP provided by SAP AG may provide the application layer protocol 114. The BCP can provide an HTTP-based semantic protocol through which XML code may be exchanged between the client 102 and the server 104. The XML code may be specified by an SCXML schema that provides a schema for a GUI object model. Because the same schema is used for both the client 102 and the server 104, the BCP can synchronize a server instance of an application user interface object model (UI object tree 110b) with a client instance of the application user interface object model (UI object tree 110a).

According to one embodiment, the BCP can include a request/response protocol. The client 102 can send a request to the server 104 in the form of a request method, URL, protocol version, or XML body content over a connection with the server 104. The server 104 can respond with a status line including the message's protocol version and a success or error code followed by XML body content. According to one embodiment, the BCP can provide for support bits that allow the client 102 and the server 104 to negotiate which features are to be used between the client 102 and the server 104 for a session.

The BCP may provide operations for delta management including a set operation, a remove operation, and a merge operation. The set operation may be used to either exchange a complete object tree or to set a complete object tree in the case of creating a new tree. A remove operation may be used to remove a complete object tree. A merge operation may be used to merge a partial object tree 112a or 112b including changes into an existing object tree. The tags, <set>, <remove> and/or <merge>, may be embedded in a partial object tree 112b sent from the server 104 to the client 102. These tags may be detected by the document handler 207 on the MBC 106, which may then cause the instantiation, destruction or alternation of objects in the model 206.

In particular, upon receiving a <merge> tag in a partial object tree 112b, the document may cause objects instantiated in the model 206 to be modified to reflect the information the partial object tree 112b. This modification may include, for example, setting various properties or attributes for the object.

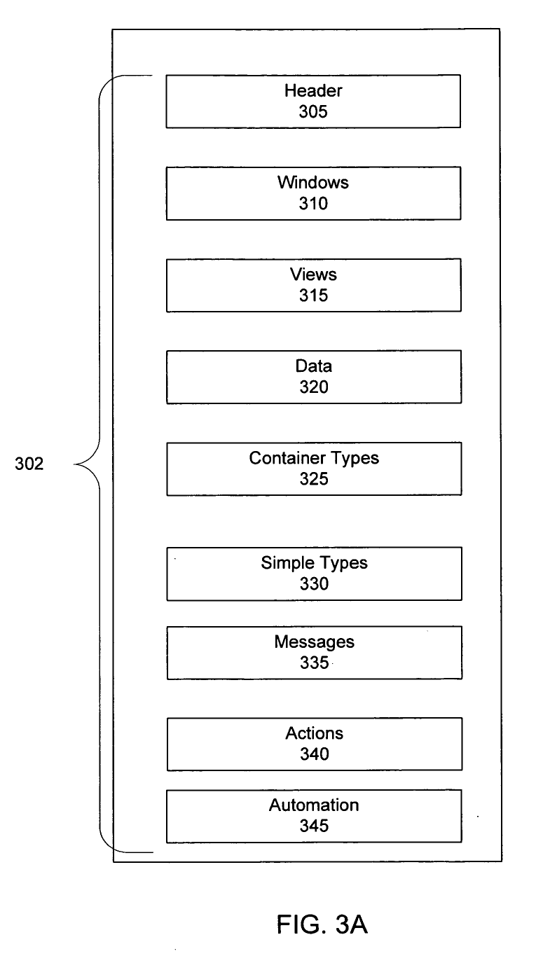

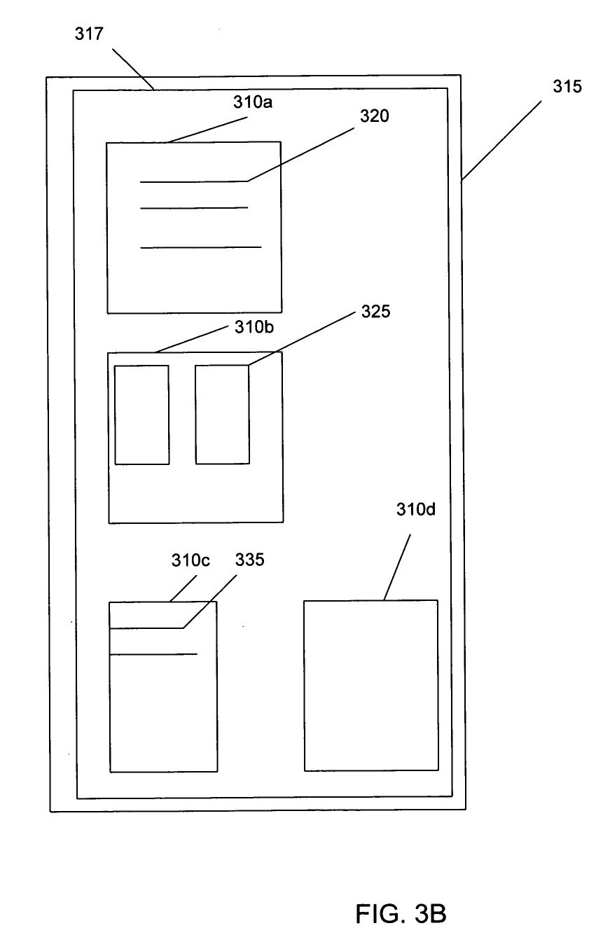

FIG. 3A is a block diagram of a SCXML schema. The SCXML schema can include views, data types, and data. Sharing the same object model between a client 102 and a server 104 facilitates delta synchronization of the UI object model between a client 102 and a server 104. The SCXML schema may specify a GUI object tree for various GUI objects that may be displayed in a GUI 140.

The UI object tree may be coded using XML or SCXML. According to one embodiment, the root element of the UI object tree is <SCXML> 302, which can include the following sub-elements: Header element 305, Windows element 310, Views element 315, Data element 320, ContainerTypes element 325, SimpleTypes element 330, Messages element 335, Actions element 340, and Automation element 345.

The Windows element 310 may specify the client application's windows. In particular, the Windows element 310 may specify a hierarchy of windows and their locations on in the GUI 140. Typically the windows element 310 is the highest level of container and contains at least one view element 315.

The Views element 315 may provide a container for controls. Controls may include such items as a text box object, list box object, etc. Each object may be related to data that it contains. For example, a text box object may be associated with particular data that is to be displayed in that text box. The Data element 320 may provide data linked to UI types.

The ContainerTypes element 325 may specify the complex type structure of data containers within the Data element 320 by referring to simple types defined in the SimpleTypes element 330. The simple types element 330 may specify simple types, e.g., value sets for enumerated types. The Messages element 335 may specify the user messages that are displayed depending upon some user interaction with the client 102, for example, include error messages, warning messages, fatal error messages, and information messages.

The Actions element 340 may specify user actions on the client 102. An action may be defined for a UI component. For example, an action may be defined for a button to submit a request. The Automation element 345 may provide functionally to facilitate invocations of different types, e.g., EventHandler, WindowHandler, DeltaHandler, ActionHandler, PageHandler, etc

FIG. 3B schematically shows how various elements specified in a SCXML document may correspond to various GUI elements. The windows element 315 may include a view 317 that serves as a container for controls 310a-310d.

Table 1 below describes types that can be used to characterize a UI object tree 110a or 110b and describes how each type supports delta management operations in a client-server system.

TABLE 1

| | | Support for | | |
|---|---|---|---|---|
| | | Delta | | |
| Main Element | Description | Operations | Response | Request |
| Header | Localization, client, | Yes | Yes | Yes |
| | server | | | |
| Windows | The stack of modal | Yes | Yes | No |
| | windows | | | |
| Messages | User messages | No | Yes | No |
| | including errors, | | | |
| | warnings and | | | |
| | information | | | |
| SimpleTypes | Simple data type | Yes | Yes | No |
| | information | | | |
| | according to XML | | | |
| | schema | | | |
| ContainerTypes | Complex data type | Yes | Yes | No |
| | information | | | |
| | according to XML | | | |
| | schema | | | |
| Data | Application data, | Yes | Yes | Yes |
| | e.g. field contents, | | | |
| | table and tree data | | | |
| Views | Views including | Yes | Yes | Yes |
| | their UI types | | | |
| | and hierarchy | | | |
| Actions | Event subscriptions | Yes | Yes | No |
| Automation | Method invocation | No | Yes | Yes |
| | queue | | | |
| Pages | Paged content sent | No | Yes | No |
| | by the server | | | |

In addition, Table 2 below sets forth the support for set, remove, and merge operations that may be defined for various elements in an object tree:

TABLE 2

| | Response Delta | Request Delta |
|---|---|---|
| Main Element | Operations | Operations |
| Header | Set | Merge |
| Windows | Set | N.A. |
| SimpleTypes | Set, Remove | N.A. |
| ContainerTypes | Set, Remove | N.A. |
| Data | Set, Remove | Merge |
| | (Merge: Support Bit 10) | |
| Views | Set, Remove | Merge |
| Actions | Set, Remove | N.A. |

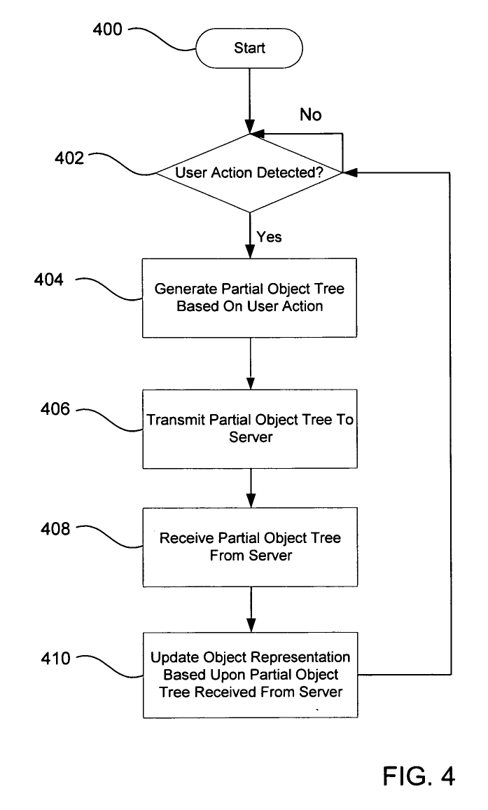

FIG. 4 is a flowchart depicting steps performed by a mobile business client in order to support delta management. The process is initiated in step 400. In step 402, it is determined whether a user has generated an action by interacting with a GUI object. An action may include clicking on a button, typing text into a text box, moving or resizing a window or any other action that relates to the GUI 140. An action may be detected by an event listener which may be part of a UI layer module in the MBC 106 (not shown in FIG. 1A. The UI layer module may provide notification to the controller module (also part of the MBC 106), which may then take further action based on upon the action. When the server 104 sends a partial object tree 112 relating to a particular control, it sends back a list of actions that are defined for that element. For example, if the server 104 sends a partial object tree 112b corresponding to a button, the partial object tree might include an actions element that indicates that a click action is possible for the button. If no event is detected (‘no’ branch of step 402), flow continues with step 402 and the test is performed again.

When an event is detected (‘yes’ branch of step 402), flow continues with step 404 and a partial object tree (112a) is generated. The partial object tree 112a that is generated may include information relating to the detected user action. The partial object tree 112a generated may be structured according to a schema 116 defined for the application layer protocol 114. The schema 112 may provide for an actions element that provides for the structuring of information relating to actions generated on the client 102. For example, if a user clicks on a button, the generated partial object tree may include information relating to the button that was clicked. Alternatively, in another example, if a user enters his name into a text field of a form, a partial object tree 112a may be generated including the text that was typed as well as the action associated with the user's entering of text (e.g., clicking on a button).

In step 406, the partial object tree 112a is transmitted to the server 114. Transmission of the partial object tree 112a may be handled by the protocol handler in the MBC 106. The server 104 receives the partial object tree 112a, parses the tree and may perform some processing based upon the information contained in the partial object tree 112a. The server 104 may then generate a new partial object tree 112b, which it transmits to the client 102. The server 104 may then update state information 110 indicating the partial object tree 112b information it has sent to the client 102.

In step 408, the client 102 receives the partial object tree 112b from the server via a protocol handler, which is part of the MBC 106. The MBC 106 parses the received partial object tree 112b using an XML parser. In step 410, the client 102 updates the model 206a based upon the partial object tree 112b that is received from the server 104. Flow then continues with step 402, and a test for a user event is performed again.

Several examples of the exchange of partial object trees 112a and 112b that utilize an SCXML schema provided for the BCP and the corresponding update of the model in the MBC 206 are now described. According to one example, a form displayed on the GUI 140 may provide a cancel button and a create button. Thus, it is assumed that an object for the create button has already been instantiated in the model 206. It is also assumed that a “click” action has been defined for the create button via a previous partial object tree 112b sent from the server 104 to the client 102. If a user takes the action of clicking on the create button, the create button should then appear disabled in the GUI 140. In order to provide this update to the GUI, upon detection of the user click action, the UI controller 208 may cause creation of a partial object tree 112a containing information relating to the action of clicking on the button and cause the protocol handler 212 to send this partial object tree 212a to the server 104. In this case the partial object tree 112a would store the information relating to the click in the actions element 340 as well as the information relating to the corresponding button in views element 315. The server 104 may respond by sending back a partial object tree 112b to the client 102, which is received by the protocol handler 212. The partial object tree 112b may contain a views element 340 with a <merge> tag including information that indicates that a property entitled “disable” is set to “true”.

According to another example, a user might fill out a form with a number of fields. The user might inadvertently miss filling in one particular field. In this case, the server 104 may send back a partial object tree 112b with a message element 335 including text information to alert user “please fill out the required field”. This message element might then be added to the existing view. As will be described below, the BCP provides an SCXML schema that includes a messages element.

Although the above examples have been provided for the sake of explanation, it should be understood that many other embodiments may be implemented.

Implementations of the various techniques described herein may be implemented in digital electronic circuitry, or in computer hardware, firmware, software, or in combinations of them. Implementations may include a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include GPRS, EDGE a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A method of performing delta updates of a Web-based application running on a client device in a client-server system, the method comprising:
storing an object tree on the client, the object tree specifying at least one Graphical User Interface (“GUI”) object for the application;
storing in an object cache on the client at least one instance of the GUI object specified in the object tree;
detecting a user interaction with the GUI object;
upon detection of the user interaction with the GUI object, generating a first portion of an object tree based on the user interaction;
transmitting the first portion of the object tree from the client to a server;
receiving a second portion of an object tree from the server;
upon receiving the second portion, modifying the object tree stored on the client based upon information in the second portion; and
updating the cache based upon information in the second portion.

2. The method of claim 1, wherein the object tree comprises XML data.

3. The method of claim 1, further comprising transmitting the first portion of the object tree via an HTTP protocol.

4. The method of claim 1, wherein the second portion of an object tree includes an indicator for specifying at least one of the creation of an object, the deletion of an object, or the replacement of an object.

5. The method of claim 4, wherein updating the object cache comprises creating a new object in the cache if an indicator is present in the second portion of the object tree indicating that the object should be created.

6. The method of claim 4, wherein updating the object cache comprises deleting an object in the cache if an indicator is present in the second portion of an object tree indicating that the object should be deleted.

7. The method of claim 4, wherein updating the object cache comprises replacing an object in the cache with a new object if an indicator is present in the second portion of an object tree indicating that the object should be replaced.

8. A system for performing delta updates of GUI information for a Web-based application comprising:
a memory element adapted for storing an object tree, the object tree specifying at least one Graphical User Interface (“GUI”) object for the application;
an object cache adapted for storing at least one instance of a GUI object specified in the object tree;
a processor, wherein the processor is adapted to:
upon detecting a user interaction with a GUI object, modify a portion of the object tree to reflect the user interaction;
transmit a first portion of the object tree from the client to a server;
wherein the first portion corresponds to the modified portion of the object tree;
receive a second portion of the object tree from the server,
modify the object tree to reflect the second portion; and,
update the object cache to reflect the objects specified in the object tree.

9. The system of claim 8, wherein the object tree includes XML data.

10. The system of claim 8, wherein transmitting the object tree comprises transmitting the tree using an HTTP protocol.

11. The system of claim 8, wherein the object tree includes indicators for specifying at least one of the creation of an object, the deletion of an object, or the replacement of an object.

12. The system of claim 11, wherein the processor is further adapted to create a new object in the cache if an indicator is present in the object tree indicating that the object should be created.

13. The system of claim 8, wherein the processor is further adapted to delete an object in the cache if an indicator is present in the object tree indicating that the object should be deleted.

14. The system of claim 8, wherein the processor is further adapted to replace an existing object in the cache with a new object if an indicator is present in the object tree indicating that the existing object should be replaced.

15. A client adapted to provide delta updates of GUI information for a Web-based software application comprising:
a protocol handler adapted to communicate with a server to receive an object representation of GUI information for the application;
a parser adapted to parse the object representation and generate at least one instance of an object specified in the object representation;
a cache adapted to store the at least object instance generated by the parser; and,
a UI (“User Interface”) controller, wherein the UI controller renders a GUI based on objects stored in the cache.

16. The client of claim 15, wherein the object representation is XML data.

17. The client of claim 15, wherein the object representation is transmitted using the HTTP protocol.

18. The client of claim 15, wherein the protocol handler utilizes a protocol for communication with a server that provides for the exchange of only a portion of an object representation.

19. The client of claim 18, wherein the protocol provides indicators for specifying at least one of the creation of an object, the deletion of an object and the replacement of an object.

20. The client of claim 18, wherein the parser updates the object cache if an indicator is present in the object tree indicating that an object should be created.
